(19) United States
(12) Patent Application Publication
(10) Pub. No.: US 2012/0312948 A1
(43) Pub. Date: Dec. 13, 2012

(54) SUPPORT SYSTEMS

(76) Inventors: Patrick David Maguire, Dunedin (NZ); Jason Paul Rogers, Pukekohn (NL)

(21) Appl. No.: 13/497,414

(22) PCT Filed: Sep. 21, 2010
(86) PCT No.: PCT/NZ10/00188

§ 371 Date: Mar. 21, 2012

(30) Foreign Application Priority Data
Sep. 21, 2009 (NZ) 579814
Oct. 7, 2009 (NZ) 580233

(51) Int. Cl. G09F 7/18; F16M 13/02

(52) U.S. Cl. 248/309.1; 248/200

(57) ABSTRACT

A support locator includes at least one body portion and at least one support portion, wherein the support portion is configured for engaging and retaining at least one strut member which holds a banner taught, and wherein the body portion is releasably connectable to a corner forming portion of a sheet of material forming the banner on the non-printed side of the banner, wherein the support portion projects substantially orthogonally out from a substantially planar body portion and wherein the plane of the body portion is parallel to that of the sheet material.

### TECHNICAL FIELD

The present invention relates to improvements in and relating to Support Systems. In particular the present invention relates to improvements relating to support systems for supporting a sheet of material. Even more particularly the present invention relates to a banner support system.

### BACKGROUND ART

The present invention has a broad variety of applications for supporting sheet material. For ease of reference however the present invention will now be described in relation to banner support systems.

At present a number of different systems exist for supporting banners.

However most systems utilise a heavy aluminium base which has a retraction system for rolling up the banner for storage and transport purposes and a pole for holding the banner erect when in use.

These systems are expensive to transport because of their weight and can be cumbersome to carry for long periods.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although number of prior art publications are referred to herein, this reference does not constitute an admission that any of these documents form part of the common general knowledge in the art, in New Zealand or in any other country.

Throughout this specification, the word “comprise”, or variations thereof such as “comprises” or “comprising”, will be understood to imply the inclusion of a stated element, integer or step, or group of elements integers or steps, but not the exclusion of any other element, integer or step, or group of elements, integers or steps.

It is an object of the present invention to address the foregoing problems or at least to provide the public with a useful choice.

Further aspects and advantages of the present invention will become apparent from the ensuing description which is given by way of example only.

### DISCLOSURE OF THE INVENTION

According to one aspect of the present invention there is provided a support locator which includes at least one body portion and at least one support portion, wherein the support portion is adapted to be capable, in use, of engaging and retaining at least one strut member, and wherein the body portion is adapted to be connectable to a sheet of material.

A support locator substantially as described above wherein the support portion projects out from a substantially planar body portion.

According to one aspect of the present invention there is provided a support locator which includes at least one body portion and at least one support portion, wherein the body portion has a connector surface, which in use, is the foundation for attaching the support locator, to at least one sheet of material, and wherein the support portion is configured to receive, at least one strut, in a direction which is substantially parallel, to the plane of the connector surface.

It is envisaged that the body portion can have a variety of different forms without departing from the scope of the present invention.

In preferred embodiments the body portion may be substantially planar in nature, or have at least one planar outer surface (connector surface) which is used for attachment to a sheet of material.

In other embodiments the body portion may include two substantially planar body portions on either side of the support portion. Preferably, there may be two connector surfaces on either side of the support portion.

In other embodiments the body portion may be shaped to surround the support portion.

In still further embodiments the body portion may be in the form of a cube, box, pyramidal or other shaped configuration.

In all preferred embodiments the base of the body portion or a part thereof may be adapted to be connectable to the sheet of material.

In some preferred embodiments the base of the body portion may be adapted to be releasably connectable to the sheet material. For example, the base of the body portion may include, but should not be limited to:
clips;
a fabric of hooks; or
a fabric of loops.

In other embodiments the body portion may include a self-adhesive layer.

In some further embodiments the body portion may be attached to the sheet of material by self-adhesive tape.

In some other embodiments the body portion may include apertures which can facilitate sewing or riveting the body portion to the sheet of material. In some embodiments the apertures may be used for attaching support portions in the forms of clips to the body portion.

The support portion may generally include, or be in the form of, an aperture which receives the strut.

However, in some embodiments the support portion may be in the form of a protrusion which engages an aperture in the support strut. For example only the support portion may be in the form of a protrusion which is constructed to releasably expand and engage into an aperture on the strut.

Alternatively, in some even further embodiments the support portion may be in the form of a clip which receives the strut. For example the clip may be a in a non-limiting example a substantially C shaped resilient member which has a mouth smaller than the sides of the C.

In preferred embodiments the support portion may be in the form of a semi-conical shaped aperture, which is positioned relative to the sheet of material in use, so as to be tapered away from, the entry point of the strut.

The support portion may be adapted to project out from the body portion in a number of different ways.

In preferred embodiments the support portion may be at least one surface which projects out from the top surface of the body portion. For example the surface may be angled at 45 degrees to the top surface.

In other preferred embodiments the support portion may be at least one surface which projects substantially orthogonally out of the top surface of the body portion. In some embodiments, the support portion may be folded out from the body portion. In such embodiments, preferably, the predefined fold line is shaped to produce an aperture.

In other embodiments the support portion may be cast or otherwise inherently formed so as to project substantially out from the body portion.

### Strut Member

The strut member may come in a variety of different forms.

In general the strut member may be a hollow at least semi rigid elongate member which is made of a lightweight material.

In preferred embodiments the strut may be tubular in nature.

In some embodiments the strut may be made of a plastic tube.

In preferred embodiments the strut may be an aluminium tube.

In some further preferred embodiments the strut may be made to have one or more sections which are adapted to be telescopically adjustable. In some preferred embodiments the sections may be two or more sub-struts which fit inside a larger sub-strut member and the smaller sub-struts may be held in position relative to the larger strut member by a hose clip or such like. The hose clip preventing the smaller sub-struts from sliding further into the larger sub-strut.

In preferred embodiments the strut at a region or point proximate the distal ends thereof may include a stop. In general, the stop may be a projection, lip or other radial protrusion which effectively holds the support locator in a set position with respect to the strut to hold the banner in taught manner. As the stop prevents the locator sliding further along the strut towards the proximate end thereof.

It should be appreciated that other arrangements to hold the locator and strut in a fixed position may also be employed without departing from the scope of the present invention.

### Sheet of Material

A sheet of material which includes support locators along at least the four corners of the sheet of material.

The sheet of material may be any sheet of material on which one wants to display a pattern, message, picture or other printed matter.

In preferred embodiments the sheet of material may be vinyl or such like. However, this should not be seen in any way as being limiting.

In some embodiments the sheet of material may be paper. In some further embodiments the sheet of material may be composed of several sheets of material which have been joined together. For example, the sheet of material may in one embodiment be made of two or more sheets of material taped together to form the message/image of the banner.

The sheet of material in some preferred embodiments may have been adapted to facilitate releasable connection of the support locators thereto. For example in embodiments where the support locator has a fabric of loops the sheet of material may have attached thereto a fabric of hooks (or vice versa) which can effect a releasable connection there between.

### Connector Device

According to one aspect of the present invention there is provided a connector device which includes at least one pair of axially opposed receiving portions wherein each receiving portion is configured to receive one end of a strut member and wherein the receiving portions include a retaining device which is coupled to at least the strut member associated with the receiving portion. A connector which includes two pair of receiving portions wherein the major axis of each pair of receiving portions intersect one another so as to substantially form a cross.

The connector device may be generally be in the form of a sleeve, or pair of axially opposed apertures in a body, which can receive and retain, in use, the ends of a strut member(s).

The retaining device may come in a variety of different forms without departing from the scope of the present invention.

In preferred embodiments the retaining device may be in the form of a flexible elastic length of material. Most preferably the retaining device may be in the form of a bungee cord.

In all embodiments the retaining device is attached to the connector device at one end and to the strut member at the other.

### Self Supporting Banner Assembly

A self supporting banner assembly which includes:
at least one sheet of material which will form the banner;
at least four support locators;
at least two strut members;
   wherein in use the support locators will be attached to the four corners of the sheet material and used to locate and retain the strut members.

A self supporting banner assembly substantially as described above which also includes a connector device.

The connector device enables the effective length of the strut members to be reduced which facilitates storage and transportation by effectively halving the length of the strut member that is required to diagonally span between diagonally opposed support locators.

A self supporting banner assembly which further includes one or more feet connected or connectable to the lower ends of the strut members.

In some embodiments the feet may connect directly to the ends of the strut protruding through the support locators.

In preferred embodiments the feet may be connected to the ends of the strut member by a T-connector.

The feet may be one or more struts.

Preferably the feet may be hollow in nature and have the same or similar attributes to the strut members.

In some further preferred embodiments the feet may include caps on each end thereof.

Thus, at least preferred embodiments of the present invention can include one or more of the following advantages over the prior art:
providing a cheap lightweight alternative to existing banner systems;
providing a more easily transportable banner system;
providing a banner that can be easily sent to a remote destination sans an accompanying person. Allowing for a self supporting banner to be sent to a remote event ahead of time and not carried as part of the baggage of an attendee.

### BRIEF DESCRIPTION OF DRAWINGS

FIG. 1 shows a perspective view of a banner support assembly which is supporting a banner according to one preferred embodiment of the present invention;

FIG. 2 shows a plan view of a support locator in accordance with one preferred embodiment of the present invention;

FIG. 3 shows a side view of the support locator shown FIG. 2;

FIG. 4 shows a plan view of a support locator in accordance with a further preferred embodiment of the present invention;

FIG. 5 shows an end on view of one of the support portions on the support locator in FIG. 4;

FIG. 6 shows an end on view of another of the support portions on the support locator in FIG. 4;

FIG. 7 shows a connector in accordance with one preferred embodiment of the present invention;

FIG. 8 Shows a connector in accordance with another preferred embodiment of the present invention;

FIG. 9 Shows the struts and connector is a stowage configuration;

FIG. 10 Shows the banner and struts and connector being stowed in a tube for storage/transport;

FIG. 11 Shows an alternate banner support assembly in accordance with another aspect of the present invention;

FIG. 12 Shows a partial view of one corner of a double sided banner using an alternate banner support assembly in accordance with yet another aspect of the present invention; and

FIG. 13 Shows the support locator in FIG. 12 in more detail.

### BEST MODES FOR CARRYING OUT THE INVENTION

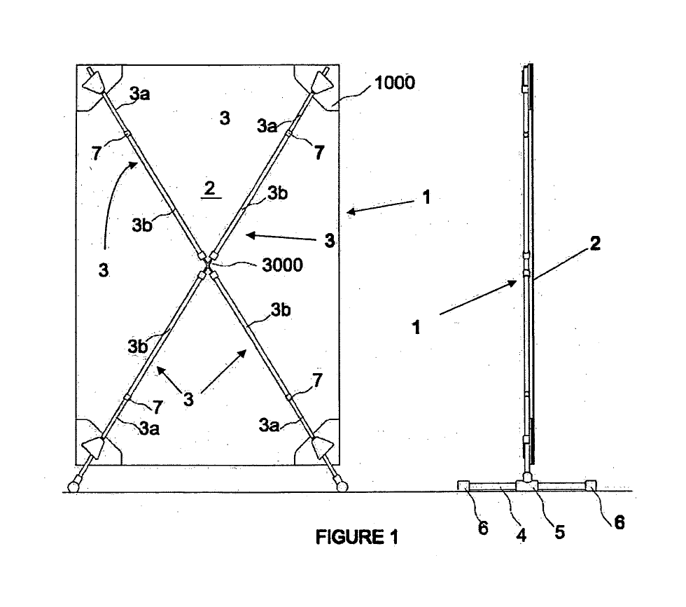

With respect to FIGS. 1-3 there is provided a banner support assembly (BSA) generally indicated by arrow 1. The BSA has a sheet of material forming the banner 2 which is held upright and in a flat plane (i.e. taught) via support locators 1000 strut members 3 and feet 4. The feet 4 are connected to the distal ends of the struts 3 via T-connectors 5. The feet 4 have end caps 6 on the distal ends thereof.

The struts members 3 have a telescopic section 3a which slides out from a proximate section 3b. The telescopic section 3a is dimensioned to slide within proximate section The distal end of proximate section 3b has a slit (not shown) in the end thereof which allows a hose clip 7 when tightened to hold the telescopic section 3a in place once it has been extended the required distance. Conversely loosening the hose clip 7 allows the bold allows for the telescopic section 3a to be further extended or retracted.

The struts 3 are attached to the banner 2 via support locators 1000 and diagonally opposed struts are joined by a connector 3000.

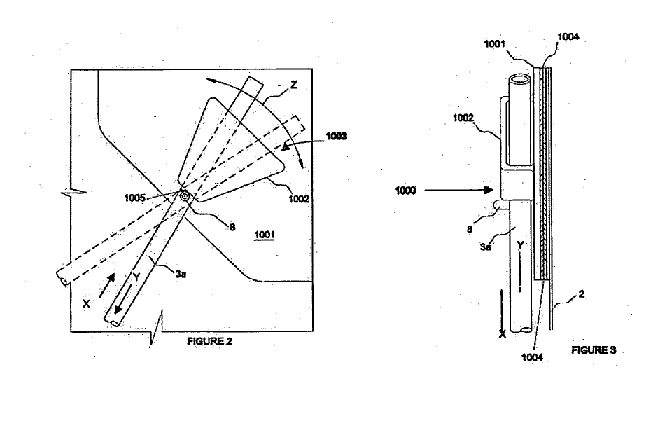

With respect to FIGS. 2 and 3 there is shown a support locator 1000 in greater detail. The support locator 1000 has a body portion 1001 which is planar in nature and a support portion 1002. The support portion 1002 is semi-conical shaped projection which creates a tapered aperture 1003 through which the distal end of the telescopic section 3a can pass. The body portion 1001 is connected to the banner 2 via an adhesive strip 1004. The telescopic portion 3a of the strut 3 has a stop in the form of a pin 8 which abuts against edge 1005 of support portion 1002. The stop 8 holds the support locator in a set position with respect to the strut 3 to hold the banner in taught manner. As the stops inhibits relative movement with respect to the strut 3a and the support locator 1000 in the direction of arrow Y towards the proximate end of the strut 3. This allows the struts 3 to exert a force in the direction of arrow X towards the support locators 1000 on each corner of the banner 2 to hold the banner taught. The semi-conical shaped projection 1002 allows for the angle of the strut 3 relative to the support locator 1000 to vary as shown be double headed arrow Z depending on the width/height of the banner.

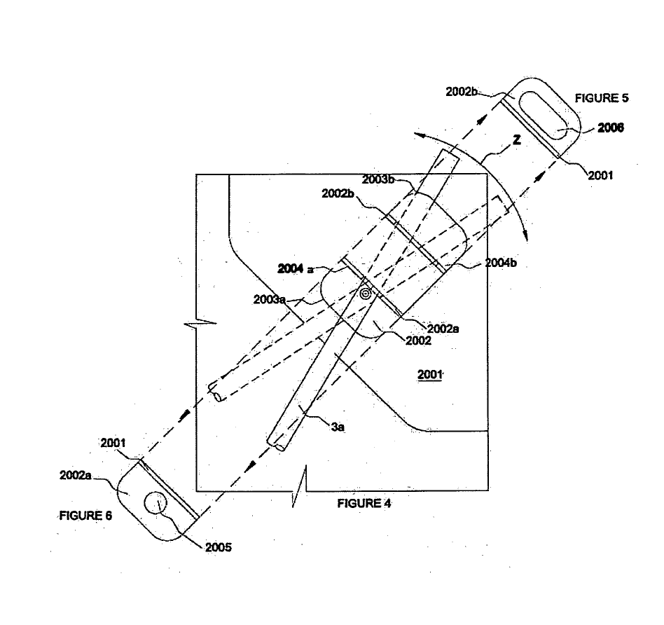

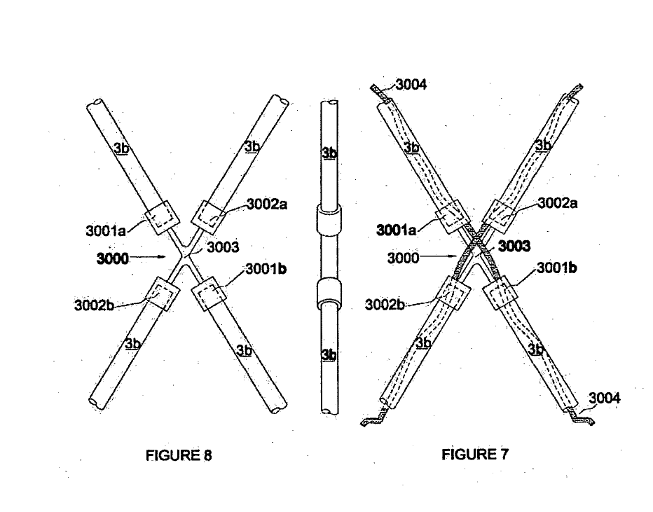

FIGS. 4-6 show an alternate support connector 2000 having a body portion 2001 and two support portions 2002a and 2002b. The support portions 2002a and 2002b are flaps which fold up from the top surface of the body portion 2001 after breaking along previously perforated lines 2003a and 2003b, and fold lines 2004a and 2004b. Support portion 2002a has a round hole 2005 and support portion 2002b has a horizontal slot 2006. The slot 2006 again allows for the angle of the strut 3 relative to the support locator 2000 to vary as shown by the dotted outline of strut 3 depending on the width/height of the banner.

FIGS. 7 & 8 shows the connector 3000 in greater detail. The connector 3000 is made from a flexible plastic such as polypropylene and has two pairs of axially opposed receiving portions in the form of sleeves 3001a, b and 3002a,b. The sleeves 3001a,b and 3002a,b are connected to one another via a cross shaped body portion 3003. The arms of the cross shaped body portion 3003 are flexible which allows for the angle between adjacent struts to vary depending on the width/height of the banner. The sleeves each have a retaining device in the form of bungee cord 3004 which is connected at either end to diagonally opposed struts 3a and travels through the centre of struts 3b.

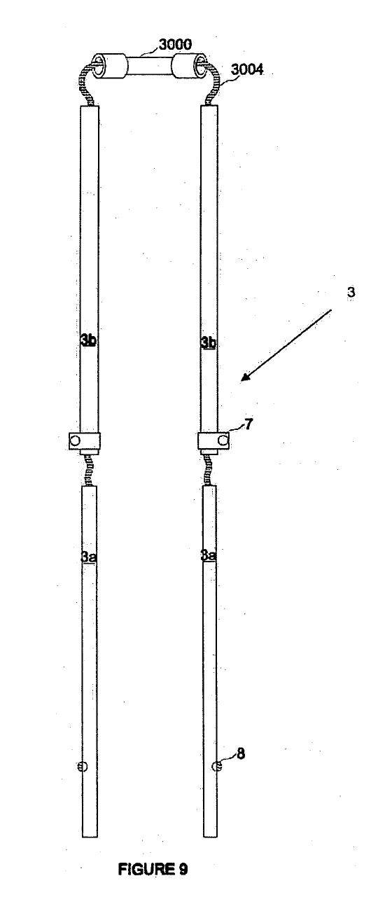

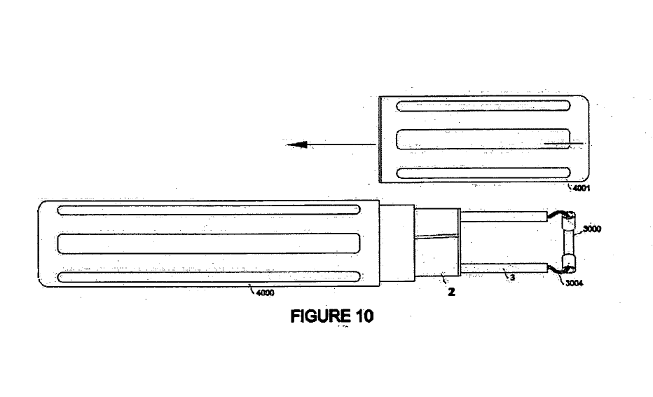

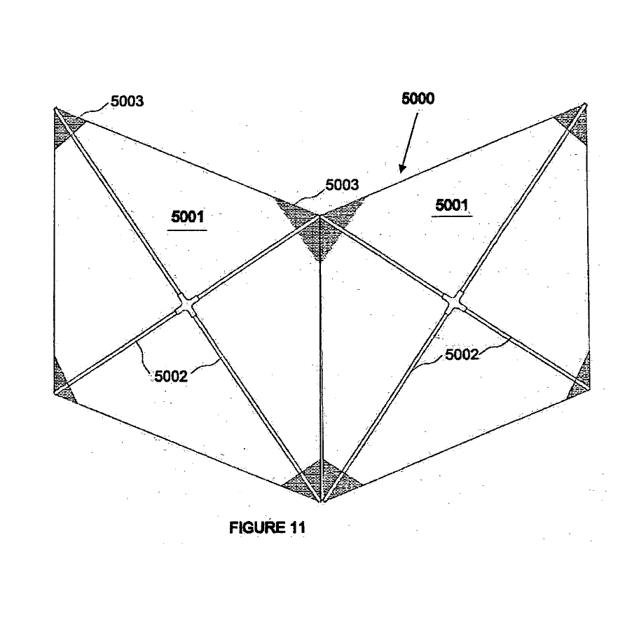

FIGS. 9 and 10 show the connector 3000 bungee 3004 and struts 3 in a collapsed configuration. In FIG. 10 the connector 3000 bungee 3004 and struts 3 are placed within the banner 2 which has been rolled up for sliding into a storage tube 4000 which has a lid 4001.

FIG. 11 shows an alternate banner support assembly as shown by arrow 5000. The banner 5001 is self standing and uses struts 5002 located in support locators 5003.

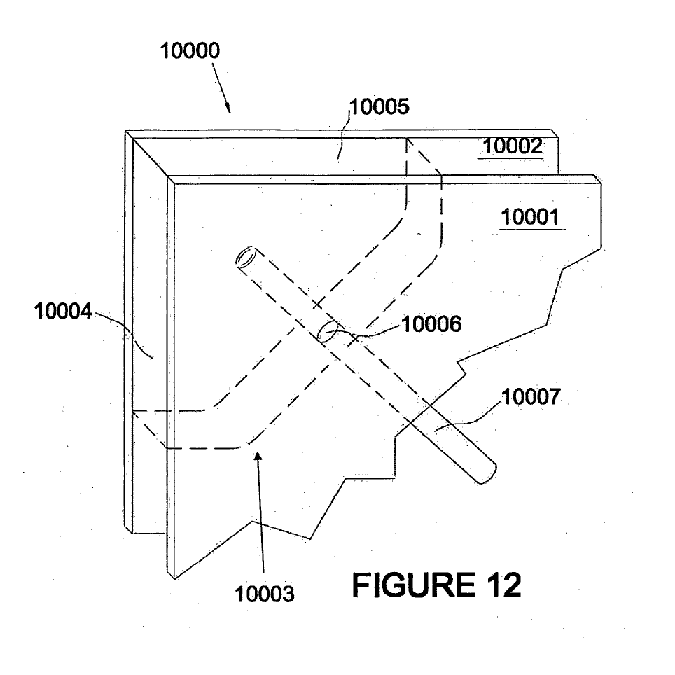

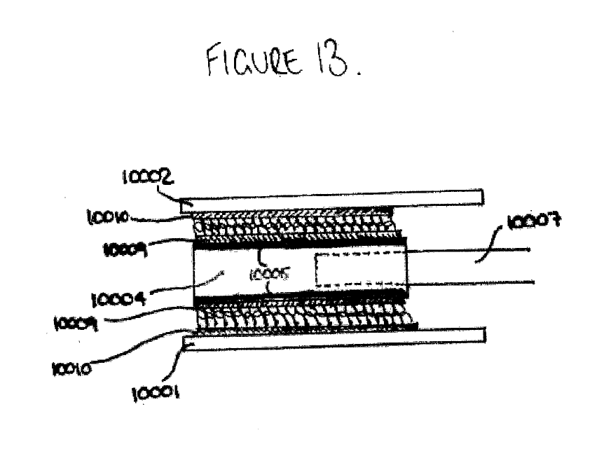

FIG. 12 shows an alternative preferred embodiment banner support assembly 10000 being used to support two sheets of material forming a first banner 10001 and second banner 10002 respectively. The banner support assembly has support locators 10003 attached to each of the four corners of the banners of which only one locator 10003 is shown positioned on the underside of: the top right hand corner of banner 10001 and left hand corner of banner 10002 respectively. The support locator has a body portion 10004 which has two connector surfaces 10005 of which only one can be seen which form the foundation for attaching the support locator to the banners 10001 and 10002 respectively. The connector surfaces have a fabric of loops in the form of a triangular VELCRO™ patch 10009 stuck thereto. This is hooked to a fabric of hooks in the from a triangular VELCRO™ patch 10010 which is attached to the underside of top right hand corner of the banner 10001. The body portion 10004 has a support portion in the form of an aperture 10006 which receives a strut member 10007.

FIG. 13 shows the VELCRO™ loop patches 10009 which are stuck via and adhesive 10008 to the connector surfaces 10005. Connected to the VELCRO™ loop patches 10009 are VELCRO™ hook patches 10010 which are connected to respective banners 10001 and 10002 via adhesive 10011.

It will be appreciated the remainder of the banner support assembly depicted in FIGS. 12 and 13 that is not shown in these figures may be substantially similar to those shown and described in the previous figures.

Aspects of the present invention have been described by way of example only and it should be appreciated that modifications and additions may be made thereof without departing from the scope of the appended claims.

What we claim is:

1. A support locator which includes at least one body portion and at least one support portion, wherein the support portion is adapted to be capable, in use, of engaging and retaining at least one strut member and wherein the body portion is adapted to be connectable to a sheet of material.

2. A support locator as claimed in claim 1 which includes at least one body portion and at least one support portion, wherein the body portion has a connector surface which, in use, is the foundation for attaching the support locator, to at least one sheet of material, and wherein the support portion is configured to receive, at least one strut, in a direction which is substantially parallel, to the plane of the connector surface.

3. A support locator as claimed in claim 1 wherein there are two substantially body portions on either side of the support portion.

4. A support locator as claimed in claim 1 the body portion includes opposed connector surfaces on either side of the support portion.

5. A support locator as claimed in any one of claims 1 to 4 wherein the connector surface(s) is/are adapted to be releasably connectable to the sheet material.

6. A strut for use with a banner wherein the strut has one or more sections adapted to be telescopically adjustable with respect of one another, and wherein the strut at point proximate the distal ends thereof includes a stop.

7. A sheet of material which includes support locators along at least the four corners of the sheet of material.

8. A sheet of material as claimed in claim 7 werein the sheet of material is adapted to facilitate releasable connection of the support locaters thereto.

9. A connector device which includes at least one pair of axially opposed receiving portions wherein each receiving portion is configured to receive one end of a strut member and wherein the receiving portions include a retaining device which is coupled to at least the strut member associated with the receiving portion.

10. A connector as claimed in claim 9 which includes two pair of receiving portions wherein the major axis of each pair of receiving portions intersect one another so as to substantially form a cross.

11. A connector as claimed in either claim 9 or claim 10 wherein the retaining device may be in the form of a flexible elastic length of material.

12. A self supporting banner assembly which includes:
at least one sheet of material which will form the banner;
at least four support locators;
at least two strut members;
wherein in use the support locators will be attached to the four corners of the sheet material and used to locate and retain the strut members.

13. A self supporting banner assembly as claimed in claim 12 which also includes a connector device.

14. A self supporting banner assembly as claimed in claim 12 or 13 wherein the assembly further includes one or more feet connected or connectable to the lower ends of the strut members.
